(19) United States
(12) Patent Application Publication
(10) Pub. No.: US 2026/0156493 A1
(43) Pub. Date: Jun. 4, 2026

(54) METHODS FOR RECEIVER SIDE TRAINING FOR ONLINE CONSTELLATION LEARNING

(71) Applicant: InterDigital Patent Holdings, Inc., Wilmington, DE (US)

(72) Inventors: Asil Koc, Verdun (CA); Mohamed Amine Arfaoui, Montreal (CA); Philip Pietraski, Jericho, NY (US); Guodong Zhang, Woodbury, NY (US); Daniel Steinbach, Commack, NY (US)

(73) Assignee: InterDigital Patent Holdings, Inc., Wilmington, DE (US)

(21) Appl. No.: 18/968,573

(22) Filed: Dec. 4, 2024

(51) Int. Cl. H04W 24/02; H04L 1/00; H04L 5/00

(52) U.S. Cl. CPC H04W 24/02; H04L 1/0061; H04L 5/0044

(57) ABSTRACT

A wireless transmit/receive unit (WTRU) comprises a processor configured to receive configuration information from a network. The configuration information may include one or more initial constellations associated with an AI/ML constellation model. The processor may be configured to receive a training message, determine estimated downlink training bits based on the online constellation learning training allocation and the one or more initial constellations, recreate a downlink training bits used by a network, determine constellation performance metrics for the one or more initial constellations based on the transmitted downlink training bits and the received downlink training bits, determine if training of the AI/ML constellation model is complete, send a message to the network indicating that training of an AI/ML constellation model is complete, generate one or more perturbation vectors, and report the one or more perturbated trained second constellations to the network if the training of AI/ML constellation model is not complete.

### BACKGROUND

The traditional square quadrature amplitude modulation (QAM) constellation has been widely used in the communication systems, including 5G NR, due to its simple structure. However, the square QAM constellations may be sub-optimal, even in the additive white gaussian noise (AWGN) channel. The optimal constellation may depend on radio and/or hardware impairments (e.g., phase noise, I/Q imbalance, carrier frequency offset), channel conditions (e.g., indoor, outdoor), channel quality (e.g., SNR), etc. Artificial intelligence (AI)/machine learning (ML) may be utilized for learning the optimal constellation. However, offline constellation learning through the datasets obtained from available and/or agreed channel models may not generalize well to dynamic channel conditions and various hardware and/or radio impairments. Additionally, online constellation learning at the transmitter side may lead to a considerable signaling overhead due to over-the-air feedback transmission from the receiver to the transmitter (e.g., gradients, learned constellation performance metrics, etc.). To mitigate the signaling overhead, it may be desirable to develop a mechanism that enables online constellation learning without the need for the feedback transmission of gradient and/or learned constellation performance metrics.

### SUMMARY

A wireless transmit/receive unit (WTRU) may comprise a processor. The processor may be configured to receive configuration information from a network regarding receiver-side training for online constellation learning in downlink. The configuration information may include, for example, one or more initial constellations. The constellations may be associated with an AI/ML constellation model. The processor may be configured to receive a training message. The training message may include, for example, an online constellation learning training allocation associated with the one or more initial constellations and/or one or more thresholds. The processor may be configured to determine a received and/or estimated downlink training bits and/or symbols based on the online constellation learning training allocation and the one or more initial constellations. The processor may be configured to generate and/or recreate downlink training bits and/or symbols used by a network. The processor may be configured to determine one or more constellation performance metrics for the one or more initial constellations based on the generated and/or recreated and/or transmitted downlink training bits and the received and/or estimated downlink training bits. The processor may be configured to determine if the training of AI/ML constellation models is complete based on the one or more constellation performance metrics and the one or more thresholds. The processor may be configured to train and/or determine one or more second constellations based on the determined one or more constellation performance metrics of the one or more initial constellations. The processor may be configured to generate one or more perturbation vectors using a pseudo-random generator (e.g., the seeds pf the pseudo-random generator may be configured by the NW). The processor may be configured to determine one or more perturbated trained second constellations by applying the generated one or more perturbation vectors to the one more trained second constellations. The processor may be configured to perturbate the trained one or more second constellations using the generated one or more perturbation vectors. The processor may be configured to report the one or more perturbated trained second constellations to the network if the training of AI/ML constellation model is not complete. The processor may be configured to send a message to the network indicating that training of an AI/ML constellation model is complete.

The downlink training bits may include, for example, data bits and/or pseudo-random data bits. The downlink training bits may include, for example, pseudo-random data bits, and the training message may include, for example, one or more seed values. The processor may be configured to generate and/or recreate the transmitted downlink training bits using the one or more seed values and a pseudo-random number generator. The downlink training bits may include, for example, data bits. The processor may be configured to generate and/or recreate the transmitted downlink training bits by reencoding decoded bits after verification by running a cyclic redundancy check (CRC) on the estimated downlink training bits.

The online constellation learning training allocation may include, for example, a set of physical downlink shared channel (PDSCH) resource elements (REs) carrying symbols modulated by the transmitted downlink training bits.

The processor may be configured to receive the set of PDSCH REs carrying the symbols that were modulated by the transmitted downlink training bits. The processor may be configured to determine the received and/or estimated downlink training bits based on the symbols and the one or more initial constellations.

The constellation performance metrics may include, for example, uncoded bit error rate (BER), BER, approximate BER, throughput, and/or AI/ML model loss. The processor may be configured to compute a measured statistic that quantifies a relation (e.g., measured distance) between the recreated and/or generated downlink training bits and the received and/or estimated downlink training bits to determine the constellation performance metrics. The processor may be configured to send a report to the network, where the report may include, for example, the constellation performance metrics.

The training message may include, for example, an uplink resource allocation for reporting the one or more constellation performance metrics. The processor may be configured to send the one or more constellation performance metrics via the uplink resource allocation indicated by the training message.

The processor may be configured to report one or more constellation performance metrics to the network. The processor may be configured to receive indication from the network to start a receiver-side training of online constellation learning in downlink.

The training message may include, for example, a set of thresholds. The processor may be configured to determine if the training of AI/ML constellation model is complete based on the determined constellation performance metrics and the configured thresholds.

The processor may be configured to send a message to the network indicating that the training of the AI/ML constellation models is complete if the training of AI/ML constellation models is complete.

The processor may be configured to train and/or generate one or more second constellations, generate one or more perturbation vectors, determine one or more perturbated trained second constellations by applying the generated one or more perturbation vectors to the one more trained second constellations, and report the one or more perturbated trained second constellations to the network if the training of AI/ML constellation model is not complete.

Downlink training bits may be transmitted or not transmitted (e.g., downlink training bits).

A WTRU may be configured to perform a method that includes one or more of the following steps. The method may include receiving configuration information from a network regarding receiver-side training for online constellation learning in downlink. The configuration information may include, for example, one or more initial constellations. The constellations may be associated with an AI/ML constellation model. The method may include receiving a training message. The training message may include, for example, an online constellation learning training allocation associated with the one or more initial constellations and/or one or more thresholds. The method may include determining a received and/or estimated downlink training bits and/or symbols based on the online constellation learning training allocation and the one or more initial constellations. The method may include generating and/or recreating downlink training bits and/or symbols used by a network. The method may include determining one or more constellation performance metrics for the one or more initial constellations based on the generated and/or recreated and/or transmitted downlink training bits and the received and/or estimated downlink training bits. The method may include determining if the training of AI/ML constellation models is complete based on the one or more constellation performance metrics and the one or more thresholds. The method may include training and/or determining one or more second constellations based on the determined one or more constellation performance metrics of the one or more initial constellations. The method may include generating one or more perturbation vectors using a pseudo-random generator (e.g., the seeds pf the pseudo-random generator may be configured by the NW). The method may include determining one or more perturbated trained second constellations by applying the generated one or more perturbation vectors to the one more trained second constellations. The method may include perturbating the trained one or more second constellations using the generated one or more perturbation vectors. The method may include reporting the one or more perturbated trained second constellations to the network if the training of AI/ML constellation model is not complete. The method may include sending a message to the network indicating that training of an AI/ML constellation model is complete.

The downlink training bits may include, for example, data bits and/or pseudo-random data bits. The downlink training bits may include, for example, pseudo-random data bits, and the training message may include, for example, one or more seed values. The method may include generating and/or recreating the transmitted downlink training bits using the one or more seed values and a pseudo-random number generator. The downlink training bits may include, for example, data bits. The method may include generating and/or recreating the transmitted downlink training bits by reencoding decoded bits after verification by running a cyclic redundancy check (CRC) on the estimated downlink training bits.

The online constellation learning training allocation may include, for example, a set of physical downlink shared channel (PDSCH) resource elements (REs) carrying symbols modulated by the transmitted downlink training bits.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a system diagram illustrating an example visualization of a Markov decision process (MDP) according to an embodiment.

FIG. 3 is a system diagram illustrating an example visualization of transmitted/received legacy 16-QAM constellation (e.g., 4 bits per symbol) according to an embodiment.

FIG. 4 is a system diagram illustrating an example effects of noise and distortion on a received legacy 16-QAM constellation according to an embodiment.

FIG. 5 is a system diagram illustrating an example visualization of a learned constellation diagram under non-linear phase noise according to an embodiment.

FIG. 6 is a system diagram illustrating an example architecture of AI/ML-based constellation according to an embodiment.

FIG. 7 is a system diagram illustrating an example architecture of AI/ML-based soft symbol demapper according to an embodiment.

FIG. 8 is a system diagram illustrating an example receiver-side training for online constellation learning in downlink according to an embodiment.

FIG. 9 is a flowchart illustrating an example procedure for WTRU procedures for receiver-side training for online constellation learning in downlink according to an embodiment.

FIG. 10 is a system diagram illustrating an example orthogonal frequency division multiplexing (OFDM) resource grid with demodulation reference signals (DMRS) and data allocations according to an embodiment.

FIGS. 11A & B are system diagrams illustrating an example block error rate (BLER) performance of learned constellation and traditional square-QAM according to an embodiment.

FIGS. 12A & B are system diagrams illustrating an example learned constellations for 6 bits per symbol according to an embodiment.

FIG. 13 is a system diagram illustrating an example receiver-side training for online constellation learning in uplink according to an embodiment.

FIG. 14 is a flowchart illustrating an example procedure for WTRU procedures for receiver-side training for online constellation learning in uplink according to an embodiment.

### DETAILED DESCRIPTION

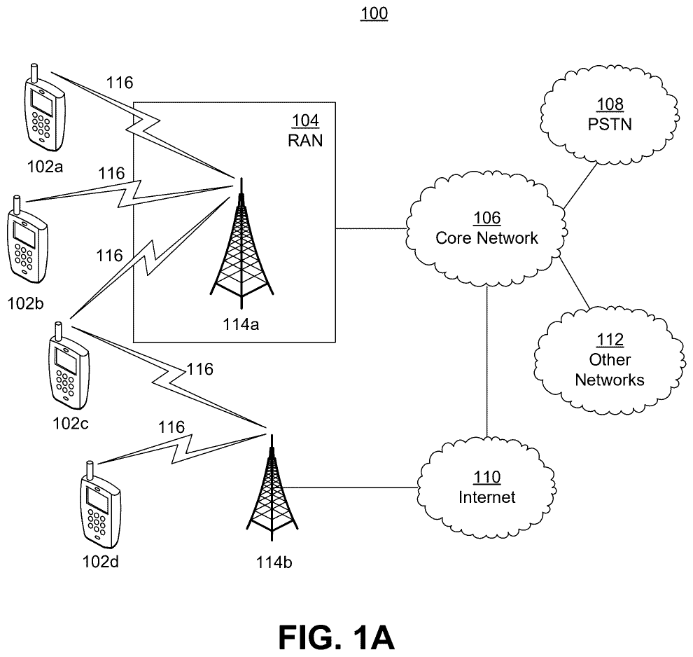

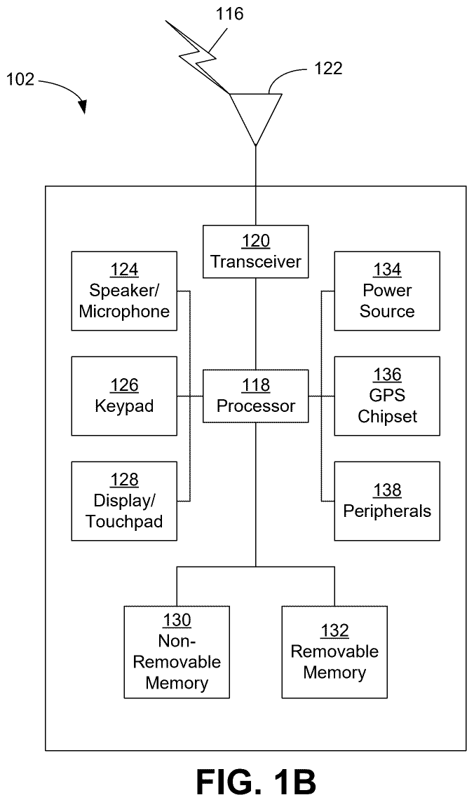

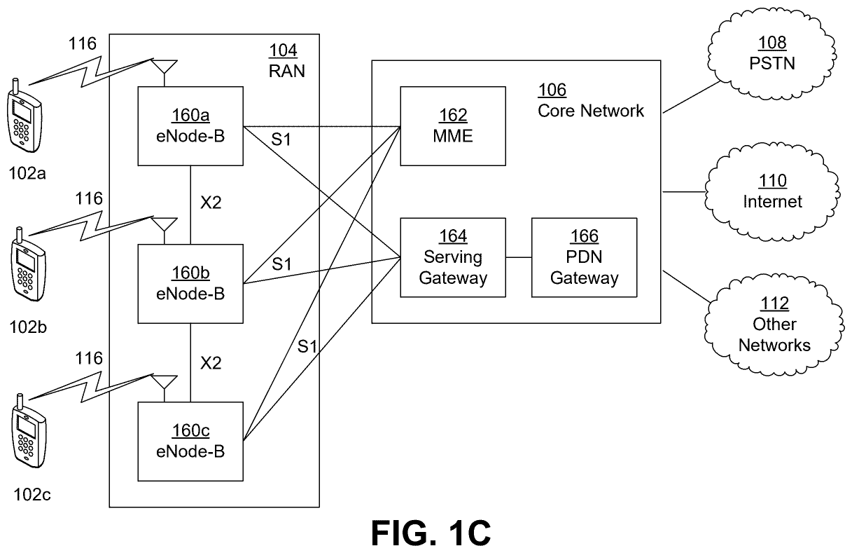

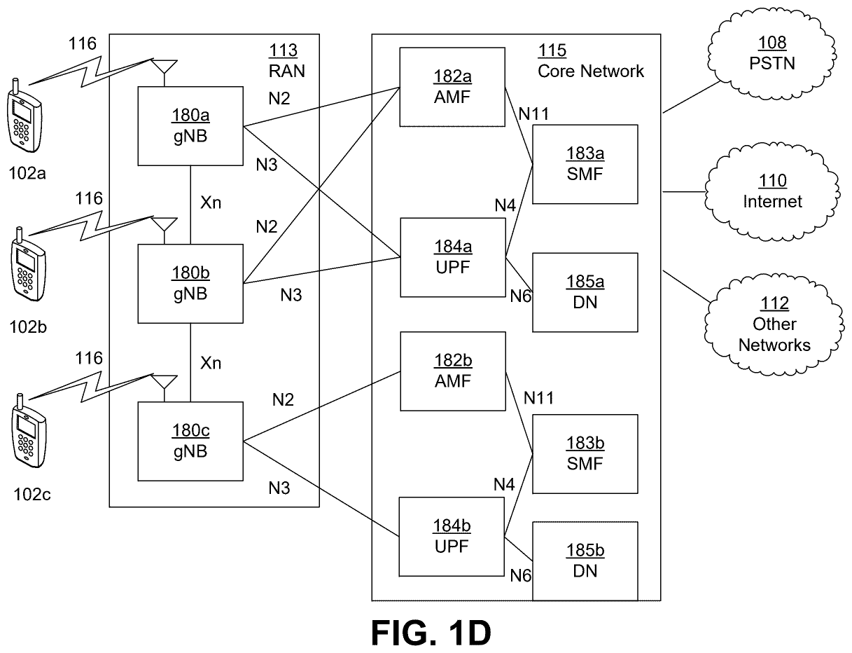

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Square quadrature amplitude modulation (QAM) constellations may be sub-optimal. The optimal constellation may depend on radio and/or hardware impairments, channel conditions, channel quality, etc. AI/ML may be utilized for learning the optimal constellation. Offline constellation learning through datasets obtained from available and/or agreed channel models may not generalize well to dynamic channel conditions and various hardware and/or radio impairments. Additionally, online constellation learning at the transmitter side may lead to a considerable signaling overhead due to over-the-air feedback transmission from the receiver to the transmitter (e.g., gradients, learned constellation performance metrics, etc.).

Online constellation learning may improve the end-to-end system performance, by adapting to the hardware and/or radio impairments and dynamic channel conditions. The example methods herein may present the steps and/or procedures enabling online constellation learning in downlink and uplink through receiver-side training. The example methods herein may first enable configuring the receiver with a set of initial constellations (e.g., square QAM, pre-trained non-square QAM). By using the training bits, the receiver calculates the learned constellation performance metrics (e.g., AI/ML model loss, symbol error rate (SER), bit error rate (BER), approximate BER, block error rate (BLER), throughput, etc.), then reports one or more of them to the transmitter as online constellation learning feedback. The receiver may calculate a reward based on the one or more learned constellation performance metrics, may train the constellation (e.g., through reinforcement learning), and then may report the learned constellation to the transmitter.

For systems using learned constellations, the example methods discussed herein describe methods for the receiver-side training for online constellation learning through reinforcement learning.

Artificial intelligence (AI) may be broadly defined as the behavior exhibited by machines that mimic cognitive functions to sense, reason, adapt and act. An AI component may refer to the realization of behaviors and/or conformance to requirements by learning based on data, without explicit configuration of sequence of steps of actions. Such AI component may enable learning complex behaviors which might be difficult to specify and/or implement when using legacy methods.

Machine learning (ML) may refer to the type of algorithms that solve a problem based on learning through experience (e.g., data), without being explicitly programmed (e.g., configuring a set of rules). ML may be considered as a subset of AI. Different ML paradigms may be envisioned based on the nature of data or feedback available to the learning algorithm. In an example, a supervised learning approach may involve learning a function that maps input to an output based on labeled training example, wherein each training example may be a pair consisting of an input and its corresponding output. In another example, an unsupervised learning approach may involve detecting patterns in the data with no pre-existing labels. In another example, a reinforcement learning approach may involve performing sequence of actions in an environment to maximize the cumulative reward. In some examples, it is possible to apply ML algorithms using a combination and/or interpolation of the above-mentioned approaches. For example, a semi-supervised learning approach may use a combination of a small amount of labeled data with a large amount of unlabeled data during training. In this regard, semi-supervised learning falls between unsupervised learning (with no labeled training data) and supervised learning (with only labeled training data).

Deep learning refers to a class of ML algorithms that employ artificial neural networks, specifically, deep neural networks (DNNs), which may be loosely inspired from biological systems. The DNNs are a special class of ML models that are inspired by the human brain wherein the input is linearly transformed and pass-through non-linear activation function multiple times. DNNs consist typically of multiple layers where each layer consists of linear transformation and a given non-linear activation function. The DNNs may be trained using the training data via a back-propagation algorithm. DNNs have shown state-of-the-art performance in a variety of domains (e.g., speech, vision, natural language, wireless communication, etc.), and for various ML settings (e.g., supervised, un-supervised, semi-supervised, etc.).

Reinforcement learning (RL) is a branch of ML that focuses on decision-making by autonomous agents. An autonomous agent represents a system capable of making independent decisions and responding to its surroundings without direct human intervention. By contrast to supervised and supervised learning, RL agents learn to act and to execute tasks through trial and error, without explicit human guidance. This approach specifically tackles sequential decision-making challenges within dynamic environments.

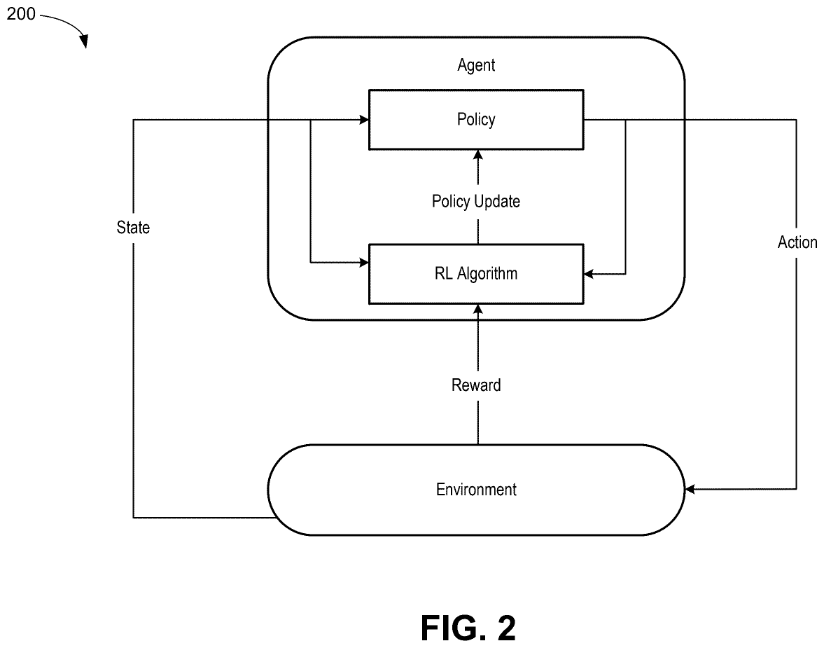

Reinforcement learning essentially consists of the relationship between an agent, an environment, and a goal. As depicted in FIG. 2, this relationship is formulated in terms of the Markov decision process (MDP). In diagram 200, the reinforcement learning agent learns about a problem by interacting with its environment. The environment provides information on its current state. The agent then uses that information to determine which actions to take. The decided action moves the environment from its current state to a new state. If that action obtains a positive reward signal from the surrounding environment, the agent is encouraged to take that action again when in a similar future state. This process repeats for every new state thereafter. Over time, the agent learns from rewards and penalties to take actions within the environment that meet a specified goal. In MDP, state space refers to all the information provided by an environment's state and action space refers to all possible actions the agent may take within a state.

As depicted in diagram 200, the agent contains two components: a policy and a learning algorithm. The policy is a mapping from the current state to a probability distribution of the actions to be taken. Within an agent, the policy is implemented by a function approximator with tunable parameters and a specific approximation model, such as neural networks. The learning algorithm continuously updates the policy parameters based on the actions, states, and rewards. The goal of the learning algorithm is to find an optimal policy that maximizes the expected cumulative long-term reward.

Because an RL agent has no manually labeled input data guiding its behavior, it must explore its environment, attempting new actions to discover those that receive rewards. From these reward signals, the agent learns to prefer actions for which it was rewarded in order to maximize its gain. But the agent must continue exploring new states and actions as well. In doing so, it can then use that experience to improve its decision-making. RL algorithms thus require an agent to both exploit knowledge of previously rewarded state-actions and explore other state-actions. The agent cannot exclusively pursue exploration and/or exploitation. It must continuously try new actions while also preferring single and/or chains of actions that produce the largest cumulative reward.

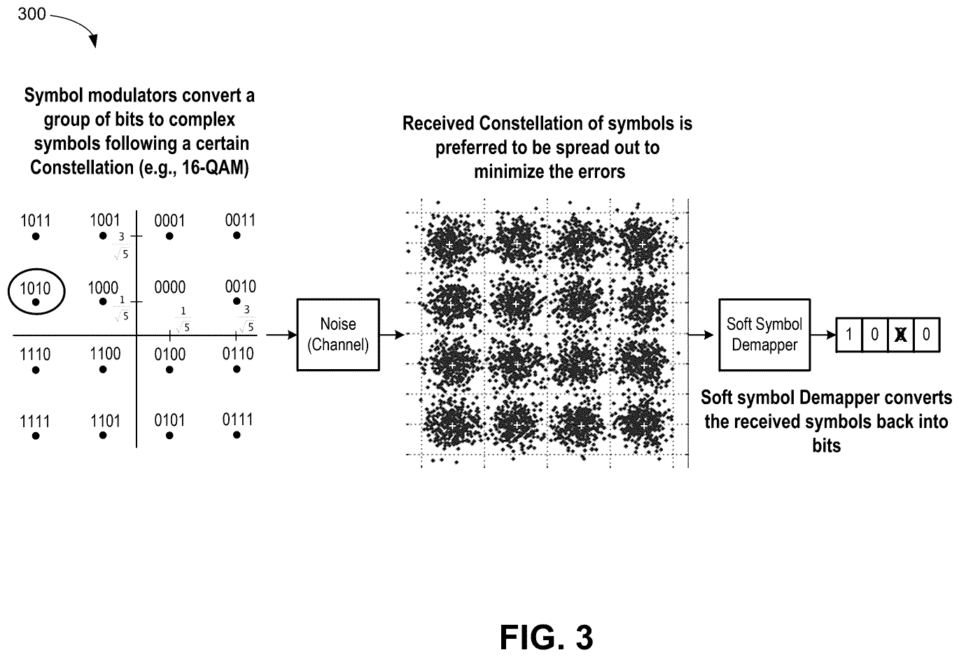

Constellation learning may be implemented. Symbol modulation and/or symbol demodulation are among the fundamental blocks of the PHY layer of wireless communications. As depicted in diagram 300 of FIG. 3, the symbol modulators convert a group of bits to complex symbols that represent the in-phase and quadrature components of the baseband signal and/or signaling, whereas symbol demodulators convert the received baseband complex signals to group of bits that are fed into the channel decoder. The number of bits carried within a symbol depends on the modulation order of the modulation scheme. The legacy symbol modulation schemes include QPSK, 16-QAM, 64-QAM, 256-QAM, 1024-QAM. The legacy constellation shapes may be based on a square grid structure. The constellations per modulation order and the corresponding MCS tables may be pre-defined.

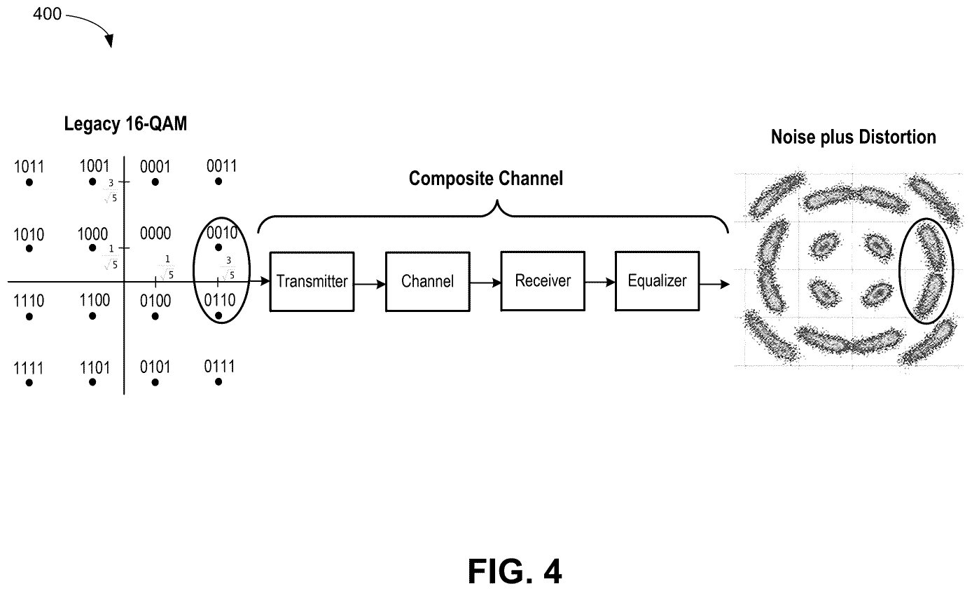

As depicted in FIG. 4, the impact of transmitter and/or receiver impairments and imperfect equalization may cause a distortion that has a more complicated effect on the received symbols. Some points in the constellation may become more error prone than others.

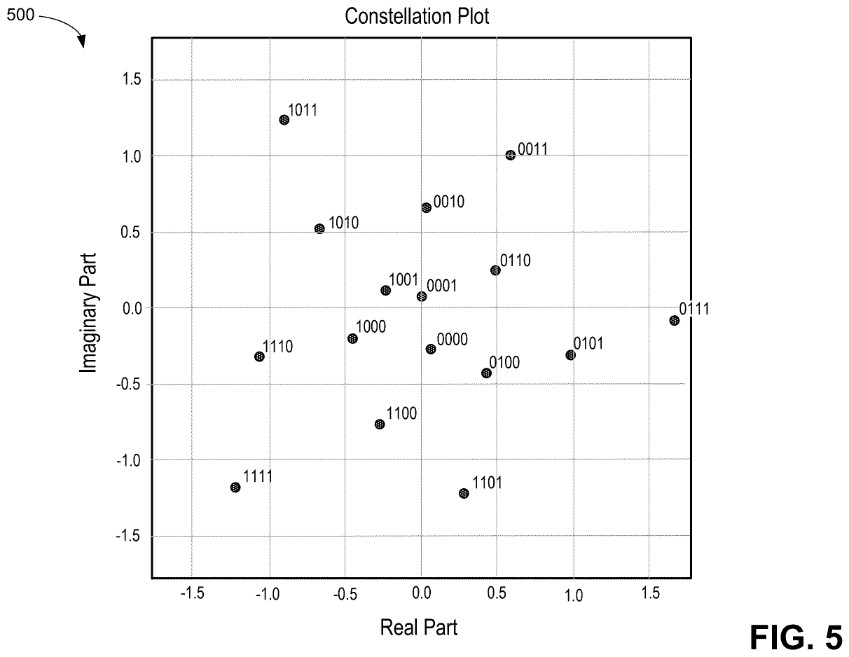

The performance of wireless communication systems depends on the choice of constellations. As shown in diagram 400, the conventional square QAM constellations are not optimal, while the optimal constellation design depends on hardware impairments and may vary over time and frequency. The learned constellations (e.g., through techniques like end-to-end learning) may improve the bit error rate and/or throughput performance through various hardware impairments. The constellation learning may be critical to compromise between performance, efficiency, and/or hardware requirements. An example of a learned constellation with modulation order 4 (i.e., 4 bits per symbol) under non-linear phase noise is show diagram 500 in FIG. 5. The end-to-end learning schemes can dynamically learn the mapper (e.g., bits to symbols) and demapper (e.g., received symbols to bits). The procedures to create and/or handle the learned constellations (e.g., mapper, de-mapper) are not defined.

Receiver-side training for online constellation learning in downlink may be implemented. Online constellation learning may improve the end-to-end system performance (e.g., BER, BLER, throughput), while adapting to the hardware and/or radio impairments and dynamic channel conditions. The example methods herein may present the steps and/or procedures that enable online constellation learning for downlink through training at the receiver side (e.g., receiver-side training). The example methods herein may first enable configuring the receiver with one or more initial constellation(s) (e.g., square QAM, trained/pre-trained non-square QAM). For the receiver-side training for online constellation learning in downlink, the network (NW) (e.g., transmitter) may use the downlink training bits (e.g., data bits, pseudo-random data bits, etc.) to create the modulated symbols, which are transmitted over-the-air to the WTRU (i.e., receiver). By using the downlink training bits, the WTRU may calculate learned constellation performance metrics (e.g., AI/ML model loss, BER, approximate BER, BLER, throughput, etc.). The WTRU may train one or more second constellation(s) (e.g., through reinforcement learning) by using the learned constellation performance metrics. For example, using RL, the WTRU may update the constellation(s) symbol points by applying perturbations to them to generate one or more second constellation(s). The WTRU may transmit the one or more second (e.g., trained) constellation(s) to the NW. The NW may send a feedback message to the WTRU indicating whether the NW uses the received second (e.g., trained) constellation(s) in the next training iteration.

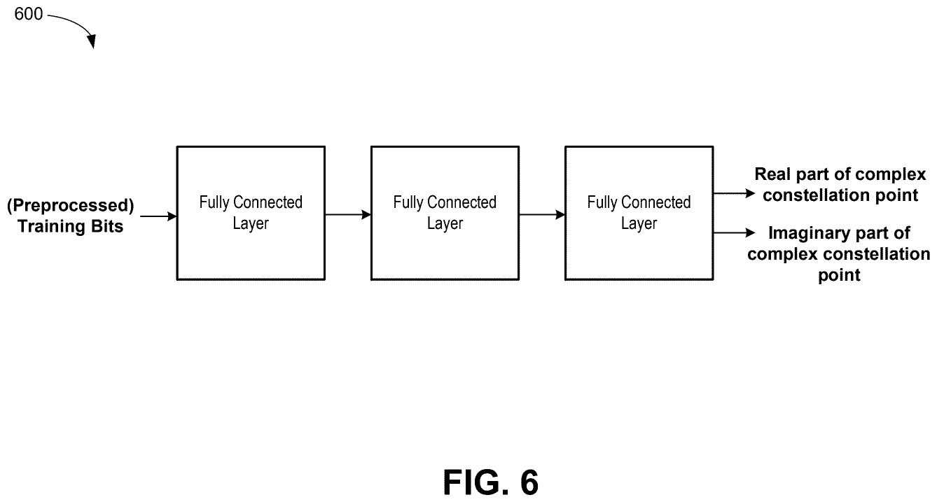

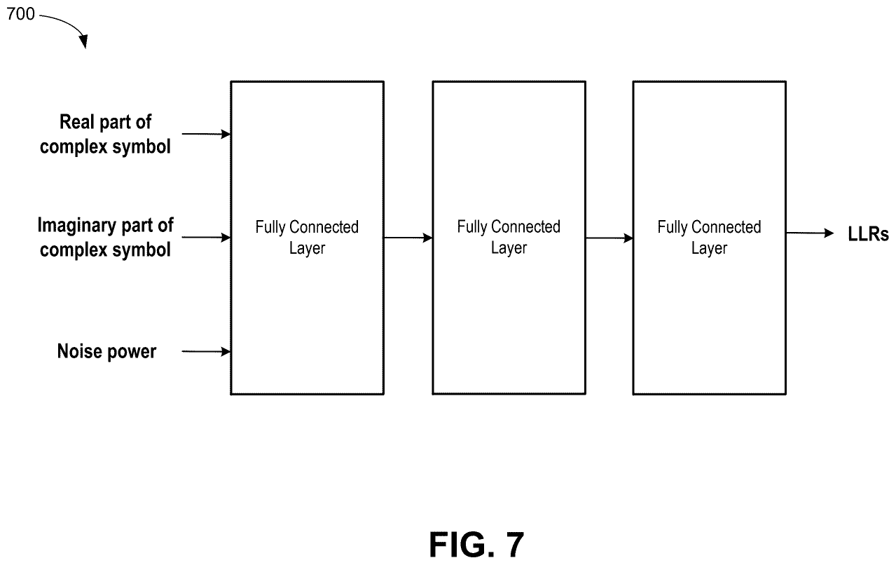

AI/ML for constellation learning in downlink may be implemented. The constellation learning may be, for example, a function that is based on two AI/ML models, one residing at the NW, and one residing at the WTRU. The AI/ML model residing at the NW, referred to as a constellation (or a constellation mapper), may map the data bits at the NW to complex constellation symbols to be transmitted to the WTRU through the downlink (DL) transmission chain (e.g., resource mapping, precoding, etc.). The AI/ML model residing at the WTRU, referred to as the soft symbol demapper, may map the equalized complex symbols from the NW to log likelihood ratios (LLRs) (e.g., hard bits), which may be then converted back to data bits. The application of AI/ML is the online constellation learning. For example, a stage of the AI/ML process may include an input data stage. The input data stage may include, for example, a constellation (e.g., downlink training bits), and/or a soft symbol demapper (e.g., equalized complex symbols at the WTRU; the estimated noise power at the WTRU may be also part of the AI/ML model input). A stage of the AI/ML process may include a preprocessing stage. The preprocessing stage may include, for example, a constellation (e.g., an optional preprocessing for the constellation may be applying channel encoding to the downlink training bits), and/or a soft symbol demapper (e.g., concatenation of the real and imaginary parts of the complex symbols to obtain the real-valued input to the AI/ML model). A stage of the AI/ML process may include an AI/ML model stage. The AI/ML model stage may include, for example, a constellation (e.g., an AI/ML model for the constellation mapper is depicted in diagram 600 of FIG. 6, which may consist of an input layer, multiple fully connected layers, and/or an output layer), and/or a soft symbol demapper (e.g., AI/ML model for the soft symbol demapper is depicted in diagram 700 of FIG. 7, which may consist of an input layer, multiple fully connected layers, and/or an output layer). A stage of the AI/ML process may include an output data stage. The output data stage may include, for example, a constellation (e.g., assuming that the constellation to be learned has an order of M, i.e., M constellation points, the input to the AI/ML model may be a codeword with log₂ M bits and the output of the AI/ML are the real and imaginary parts of the constellation point associated to the input codeword), and/or a soft symbol demapper (e.g., assuming that the constellation to be learned has an order of M, i.e., M constellation points, the inputs to the AI/ML model may be the real and imaginary parts of the received equalized symbol at the WTRU along with an estimate of the noise power at the WTRU and the output of the AI/ML model are the log₂ M LLRs associated to the √M bits of the original codeword input to the constellation mapper).

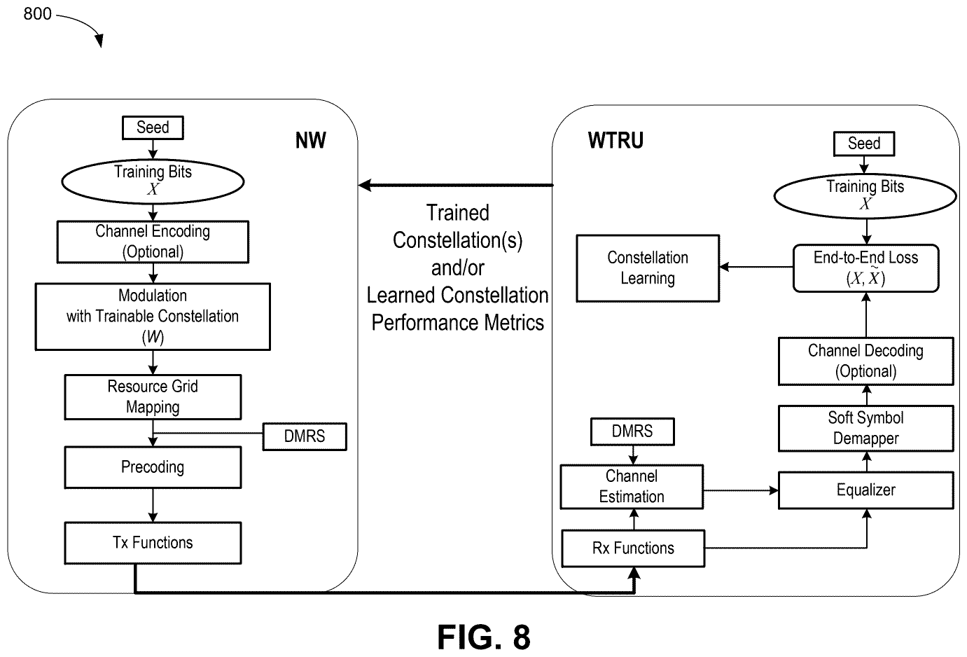

A stage of the AI/ML process may include a training stage. The NW may send the downlink training bits for the online constellation learning as shown in diagram 800 of FIG. 8. The training of constellation may be performed at the receiver-side (e.g., WTRU-side). The training may be performed through reinforcement learning. In some examples, the WTRU may compute the learned constellation performance metrics (e.g., uncoded BER, BER, approximate BER, BLER, throughput, AI/ML model loss, etc.) of one or more initial constellations. The WTRU may update the parameters of its AI/ML-based soft symbol demapper (SSD) based on the computed learned constellation performance metrics. The WTRU may report the learned constellation performance metrics to the NW. The WTRU may train the constellation using reinforcement learning. In some examples, a reinforcement learning agent may be located at the WTRU. In some examples, symbol points in the constellation and other metrics (e.g., SNR and/or SINR of the channel) may represent the state. In some examples, the WTRU may calculate the reward by using the learned constellation performance metrics. (e.g., the reward may be a vector constructed from a metric associated with each perturbation, for example, mean BCE taken over all REs with the same perturbation). In some examples, an agent may take an action to update the symbol points in the learned constellation (e.g., the agent may apply a perturbation vector to the constellations representing the action of reinforcement learning agent; the perturbation vector may include the perturbations for each symbol point in the learned constellation). In some examples, the decided action by the agent may move the environment from its current state to a new state.

WTRU capability exchange may be implemented. The NW may initiate the WTRU capability exchange process by sending the UECapabilityEnquiry RRC message to the WTRU. This message may be used to request specific information regarding the WTRU's capabilities. The NW may include parameters in this message to specify which capabilities it is interested in. In some examples, the NW may specify parameters related to WTRU's capability in supporting online constellation learning in downlink in UECapabilityEnquiry message (e.g., the capability of transmitting the constellation and the online constellation learning feedback).

Upon receiving the UECapabilityEnquiry RRC message, the WTRU may respond with the UECapabilityInformation RRC message accordingly. This message may include detailed information about the WTRU's capabilities. During the WTRU capability exchange process between the WTRU and the NW, the following key parameters related to the AI/ML functions may be included. For example, a key parameter related to the AI/ML functions may include an indicator of whether online constellation learning in downlink at the receiver side is supported or not. A key parameter related to the AI/ML functions may include an indicator of whether the configuration of multiple learned constellations is supported or not. A key parameter related to the AI/ML functions may include an indicator of whether the customization of demodulator(s) (i.e., soft symbol demapper(s)) based on the configured learned constellation(s) is supported or not. A key parameter related to the AI/ML functions may include an indicator of whether updating the learned constellation (e.g., applying constellation perturbations based on reward and state determination within the reinforcement learning framework) is supported or not. A key parameter related to the AI/ML functions may include an indicator of whether computing learned constellation performance metrics (e.g., BER, approximate BER, BLER, throughput, AI/ML model loss, etc.) is supported or not. A key parameter related to the AI/ML functions may include an indicator of whether reporting one or more trained constellations is supported or not. A key parameter related to the AI/ML functions may include an indicator of whether reporting learned constellation performance metrics (e.g., BER, approximate BER, BLER, throughput, AI/ML model loss, etc.) is supported or not. A key parameter related to the AI/ML functions may include an indicator of whether sending “training complete” message to the NW is supported or not. A key parameter related to the AI/ML functions may include an indicator of whether regenerating and/or recreating the downlink training bits is supported or not. For instance, the WTRU may regenerate and/or recreate the downlink training bits through a pseudo-random bit generator with the same seeds used by the NW, if the NW generates downlink training bits via the pseudo-random data bits. For instance, the WTRU may regenerate and/or recreate the downlink training bits through the recovered and/or estimated downlink training bits when the CRC check succeeds, if the NW generates downlink training bits via the data bits.

Through the WTRU capability exchange process as described above and herein, the NW may know the WTRU's capability to support the receiver-side training of constellation learning in downlink and use the learned constellation. For a WTRU that is capable of supporting such a function and/or feature, key parameters may be configured by the NW, which may include the following. In some examples, a key parameter that may be configured by the network may include the configuration for one or more initial constellation(s). For example, the WTRU may be configured with multiple initial constellations, for instance, a single constellation per sub-band, per Precoding Resource Block Group, and/or RB set (e.g., the first sub-band may be configured with a constellation with 16 symbols (i.e., 4 bits per symbol), while the second sub-band may be configured with a constellation with 64 symbols (i.e., 6 bits per symbol)). For example, the configured initial constellation may include a previously trained/learned constellation under a similar condition (e.g. channel conditions, hardware impairments), a trained/learned constellation during online constellation learning iterations, and/or a square QAM constellation for the first iteration of online constellation learning.

In some examples, a key parameter that may be configured by the network may include the configuration for reporting the learned constellation performance metrics. For instance, the reporting periodicity (e.g., periodic, semi-persistent, and/or aperiodic), and/or the reporting quantity (e.g., BER, approximate BER, BLER, throughput, AI/ML model loss, etc.). In some examples, a key parameter that may be configured by the network may include the configuration for reporting one or more trained constellations. For instance, the reporting periodicity (e.g., periodic, semi-persistent, and/or aperiodic).

In some examples, a key parameter that may be configured by the network may include the configuration for online constellation learning training allocations. For example, the WTRU may receive and/or estimate the downlink training bits through online constellation learning training allocations. The downlink training bits may include, for example, pseudo-random data bits generated through a seed (e.g., the WTRU may regenerate and/or recreate the downlink training bits by using the same pseudo-random bit generator as the NW with the configured seeds). The downlink training bits may include, for example, data bits (e.g., the WTRU may regenerate and/or recreate the downlink training bits through the recovered and/or estimated downlink training bits when the CRC check of the downlink data bits, through for instance PDSCH, succeeds). Seeds may be used to generate the downlink training bits at the NW. The configuration may include a code rate of forward error correction (FEC) (e.g., low density parity check (LDPC).

In some examples, a key parameter that may be configured by the network may include the configuration for learning a constellation. For instance, the configuration for learning a constellation may include for each modulation order greater than 2 bits/symbol through the configured SNR_min and SNR_max for each modulation order. The configuration for learning a constellation may include for each modulation order and code rate (e.g., per MCS) through the configured of SNR_min and SNR_max for each MCS. The configuration for learning a constellation may include for each combination of MCS (with its associated SNR range) and hardware/radio impairment class through the configured of SNR_min and SNR_max for each MCS and partitioned channel BW having a common class of hardware/radio impairments.

In some examples, a key parameter that may be configured by the network may include the uplink resource grants and/or allocation that indicate the uplink physical resources to be used for transmitting the one or more trained constellations. In some examples, a key parameter that may be configured by the network may include the uplink resource grants and/or allocation that indicate the uplink physical resources to be used for transmitting the online constellation learning feedback (e.g., learned constellation performance metrics). In some examples, a key parameter that may be configured by the network may include the training related information, which may include the following. For example, the training related information may include the learning algorithm, learning rates, and/or regularization parameters, etc. The training related information may include the total number of training sessions. The training related information may include the end-to-end loss function (e.g., binary cross entropy and/or mean square error). The training related information may include the thresholds to monitor the training progress of each configured learned constellation. The training related information may include the learned constellation performance metrics (e.g., uncoded BER, BER, approximate BER, BLER, throughput, and/or AI/ML model loss, etc.).

The following signaling may be defined to enable the WTRU and/or NW to detect the need for initiating online constellation learning, and to enable the WTRU to train the constellation(s). In some examples, a signaling may be defined to enable the WTRU to receive a request to report its hardware impairment information (e.g., phase noise, I/Q imbalance, carrier frequency offset, and/or power amplifier (PA) nonlinearities) transmitted from the NW to the WTRU (e.g., through RRC signaling). In some examples, a signaling may be defined to enable the NW to receive a report with the hardware impairment information transmitted from the WTRU to the NW (e.g., through RRC signaling). In some examples, a signaling may be defined to enable the WTRU to receive training activation for the online constellation learning transmitted from the NW to the WTRU (e.g., through DCI and/or MAC-CE). In some examples, a signaling may be defined to enable the WTRU to receive configuration for online constellation learning training allocations transmitted from the NW to the WTRU. In some examples, a signaling may be defined to enable the NW to receive trained constellation diagram(s) transmitted from the WTRU to the NW (e.g., through UCI and/or MAC-CE). In some examples, a signaling may be defined to enable the NW to receive learned constellation performance metrics transmitted from the WTRU to the NW (e.g., through UCI and/or MAC-CE). In some examples, a signaling may be defined to enable the NW to receive online constellation learning feedback transmitted from the WTRU to the NW. In some examples, a signaling may be defined to enable the NW to receive an indication that training is complete transmitted from the WTRU to the NW. In some examples, a signaling may be defined to enable the WTRU to receive an indication that training is complete transmitted from the NW to the WTRU.

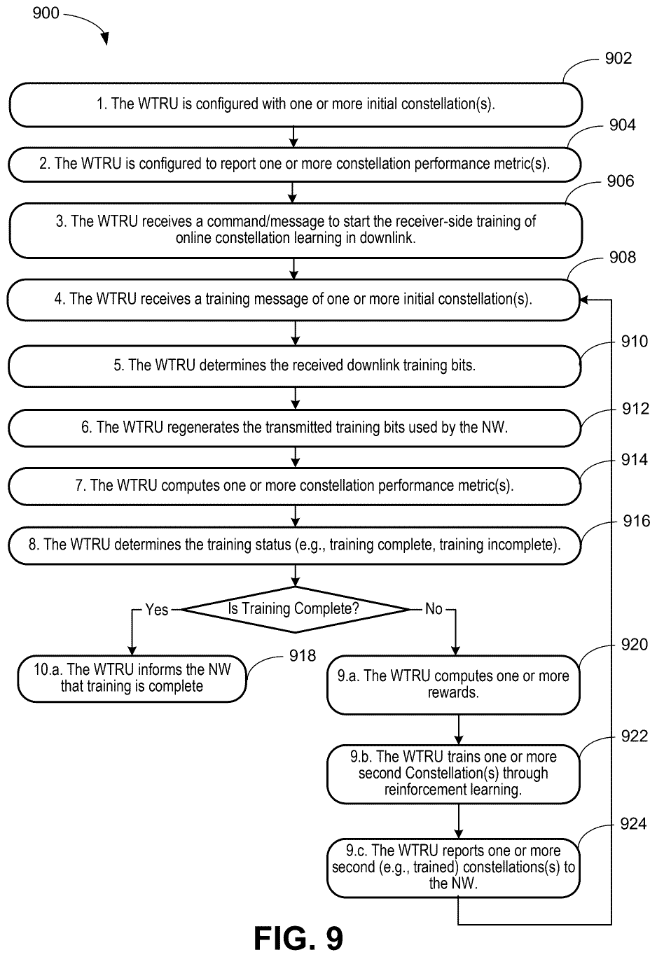

The methods and/or procedures for enabling the receiver-side training for online constellation learning for downlink are discussed below and summarized in FIG. 9. The NW may refer to any node in the network, for example, a gNB, another WTRU (e.g., Sidelink, WTRU-to-WTRU direct communication), etc.

In some examples, the WTRU may be configured (e.g., through RRC signaling) with one or more initial constellation(s). For example, the WTRU may be configured with an initial constellation for each modulation order. The WTRU may be configured with multiple initial constellation (e.g., a single constellation per sub-band, per precoding resource block group, per resource block (RB) set, and/or per layer). For instance, each sub-band may be configured with a constellation. The configured modulation order of each sub-band may be the same or different. For instance, the first sub-band may be configured with a constellation with 16 symbols (e.g., 4 bits per symbol), while the second sub-band may be configured with a constellation with 64 symbols (e.g., 6 bits per symbol). The configured initial constellation may include a previously trained and/or learned constellation under a similar condition (e.g. channel conditions, hardware impairments, etc.). The configured initial constellation may include a trained and/or learned constellation during online constellation learning iterations. The configured initial constellation may include a square QAM constellation for the first iteration of online constellation learning.

In some examples, the WTRU may be configured (e.g. by RRC signaling) to report one or more constellation performance metrics. The constellation performance metrics may include, at least one of BER, approximate BER, BLER, throughput, AI/ML model loss, etc. a. For example, the WTRU may determine one or more constellation performance metrics for one or more configured constellation(s). For example, the WTRU may report one or more of the determined constellation performance metrics to the NW (e.g., through uplink control information (UCI) and/or medium access control-control element (MAC-CE).

In some examples, the WTRU may receive a command and/or message to start the receiver-side training for online constellation learning in downlink. Triggers to initiate constellation learning may include one or more of the following. For example, triggers to initiate constellation learning may include the WTRU being configured to use AI/ML for constellation learning (e.g., for a first time). Triggers to initiate constellation learning may include the WTRU and/or the NW detecting a need to start constellation learning and/or shaping. For example, the AI/ML model's drift detection mechanisms at the WTRU and/or the NW may indicate that the AI/ML models have drifted and/or are drifting. For example, the WTRU may enter a geographic region and/or a cell (e.g., a new cell ID and/or a new registration area) for which the constellation has not been previously trained. For instance, the WTRU may compare GPS coordinates to measure distance to previously trained regions. If distance is above a threshold provided by the NW, the WTRU may signal the NW indicating the threshold is exceeded, and possibly the distance and the current location. The training for the online constellation learning may be periodic, aperiodic, or semi-persistent.

In some examples, the WTRU may receive (e.g., from the NW) a training message for the receiver-side training for online constellation learning in the downlink of one or more initial constellation(s). The training message may be configured either by RRC signaling and/or be dynamically signaled by DCI or MAC-CE. The training message may include online constellation learning training allocations. Online constellation learning training allocations may include, for example, a set of physical downlink shared channel (PDSCH) resource elements (REs) carrying the symbols modulated by a set of downlink training bits during online constellation learning training allocations. Examples of the set of downlink training bits may include, for example, pseudo-random data bits generated through one or multiple seeds, data bits, preconfigured set of data bits, and/or indicated set of data bits.

In some examples, the training message may include the uplink resource allocation and/or scheduling grants for reporting one or more second (e.g., trained) constellation(s) and/or learned constellation performance metrics. The WTRU may be configured to learn a constellation for each modulation order greater than 2 bits/symbol through the configured signal-to-noise minimum (SNR_min) and SNR_max for each modulation order. The WTRU may be configured to learn a constellation for each modulation order and code rate (e.g., per modulation and coding scheme (MCS)) through the configured SNR_min and SNR_max for each MCS. The WTRU may be configured to learn a constellation for each combination of MCS with its associated SNR range and hardware and/or radio impairment class through the configured SNR_min and SNR_max for each MCS and partitioned channel bandwidth (BW) (e.g., sub-band) with a common class of hardware and/or radio impairments.

In some examples, the training message may include training related information. For example, the training related information may include seed(s) to regenerate and/or recreate the downlink training bits used by the NW. The training related information may include seed(s) to generate pseudo-random perturbations for creating perturbations for groups of REs. The training related information may include configuration about which group of REs are associated with which perturbation. The training related information may include a set of code rate for forward error correction (FEC) (e.g., low density parity check (LDPC)). A set of code rates for FEC may be, for instance, a code rate for each configured constellation. A set of code rates for FEC may be, for instance, a fixed code rate for all configured constellations.

The training related information may include a set of thresholds to monitor the training progress of each configured learned constellation. The training related information may include a set of learned constellation performance metrics (e.g., uncoded BER, BER, approximate BER, BLER, throughput, AI/ML model loss, etc.), which the WTRU may report to the NW during the online constellation learning iterations. For example, the AI/ML model loss function may be different for each configured learned constellation. For example, the WTRU may compute the recovered and/or estimated downlink training bits by processing the received allocated transmission to produce a multi-bit resolution estimate of the downlink training bits (e.g., the recovered and/or estimated downlink training bits may be soft bits such as log-likelihood ratios (LLRs)). The recovered and/or estimated downlink training bits may be, for instance, computed before FEC decoder, where they are referred to as coded bits or raw bits, and/or may be computed after FEC where they are referred to as decoded bits.

In some examples, the WTRU may use a loss function taking as input the generated and/or recreated downlink training bits and/or the recovered and/or estimated downlink training bits to compute an end-to-end loss through the generated and/or recreated downlink training bits and/or the recovered and/or estimated downlink training bits. The examples of end-to-end loss functions may include one or more of the mean square error (MSE), binary cross entropy (BCE), and/or approximations of decoded BER, coded BER, BLER, throughput and etc.

Training information may include, for example, a configuration on calculating a set of rewards by using learned constellation performance metrics. The reward may be a vector constructed from the learned constellation performance metrics associated with each perturbation (e.g., mean AI/ML model loss over all REs with the same perturbation).

In some examples, the WTRU may determine the received and/or estimated downlink training bits based on the configured constellation learning training allocation and using the one or more initial constellation(s). In some examples, the WTRU may generate and/or recreate the transmitted downlink training bits used by the NW. For example, the WTRU may employ a pseudo-random bit generator with the same seeds and number generator used by the NW, if the NW generates downlink training bits via the pseudo-random data bits. In another example, the WTRU utilizes the hard decision applied to the received and/or estimated downlink training bits to recreate and/or generate the downlink training bits generated by the NW when the cyclic redundancy check (CRC) check succeeds (e.g., if the NW uses data bits as downlink training bits).

In some examples, the WTRU may compute one or more constellation performance metric(s) for one or more initial constellation(s) based on the generated and/or recreated transmitted downlink training bits and/or the received and/or estimated downlink training bits. The WTRU may report (e.g., dynamically through UCI or MAC-CE) the computed one or more constellation performance metric(s) for one or more initial constellation(s) to the NW.

In some examples, the WTRU may determine the training status (e.g., training complete, training incomplete) based on the one or more constellation performance metric(s) for one or more initial constellation(s) and one or more configured thresholds.

In some examples, if the training is not complete, the WTRU may compute one or more rewards by using the configured set of rewards and/or one or more constellation performance metric(s) for one or more initial constellation(s). If training is not complete, the WTRU may train one or more second constellation(s) through reinforcement learning (e.g., the reinforcement learning agent at the WTRU may take an action to update the symbol points in the one or more second constellation(s) based on the computed reward in a step where the WTRU informs the NW that the training is complete). For example, the WTRU may use exploration and/or exploitation based on at least one of: configuration, indication from NW, and/or performance metric. For example, the WTRU may use the one or more constellation performance metrics to train a single and/or multiple AI/ML model(s) for any receiver functions (e.g., a combination of channel estimator, equalizer, demodulator, and/or channel decoder).

If the training is not complete, the WTRU may report one or more second (e.g., trained) constellation(s) to the NW through the allocated uplink resources. If the training is complete, the WTRU may inform the NW that training is complete.

FIG. 9 is an example of a procedure 900 for WTRU procedures for receiver-side training for online constellation learning in downlink. The procedure 900 may be performed by a WTRU. At 902, the WTRU may be configured with one or more initial constellation(s). At 904, the WTRU may be configured to report one or more constellation performance metric(s). At 906, the WTRU may receive a command and/or message to start the receiver-side training of online constellation learning in downlink. At 908, the WTRU may receive a training message of one or more initial constellation(s). At 910, the WTRU may determine the received and/or estimated downlink training bits. At 912, the WTRU may regenerate and/or recreate the transmitted training bits used by the NW. At 914, the WTRU may compute one or more constellation performance metric(s). At 916, the WTRU may determine the training status (e.g., training complete or training incomplete). If the training is complete, at 918 the WTRU may inform the NW that the training is complete. If the training is not complete, at 920 the WTRU may compute one or more rewards, at 922 the WTRU may train one or more second constellation(s) using reinforcement learning, and at 924 the WTRU reports one or more second (e.g., trained) constellations(s) to the NW.

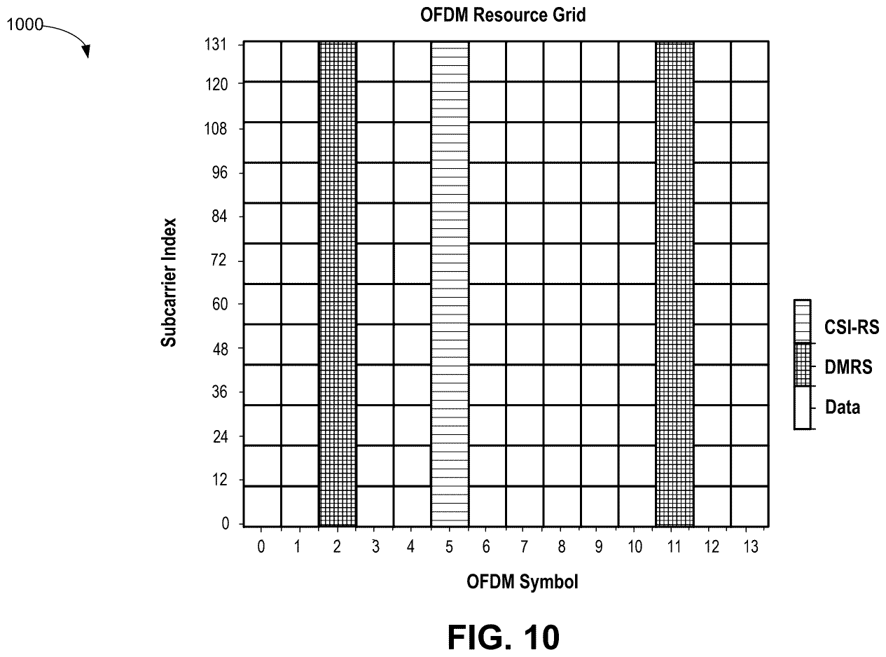

Numerical results are presented for the performance evaluation of the example online constellation learning. The simulations are performed by using Sionna, which is an open-source Python library for the link-level simulations based on TensorFlow. The simulation parameters are summarized in Table 1. The WTRU is configured with 5 MHz bandwidth with numerology μ=1 (i.e., 30 kHz subcarrier spacing, 11 RBs with 132 subcarriers). Diagram 1000 of FIG. 10 presents the OFDM resource grid with the configured DM-RS and data allocations.

TABLE 1
Simulation parameters

| Scenario | Downlink | |
|---|---|---|
| Number of Tx Antenna at gNB | 1 | |
| Number of Rx Antenna at WTRU | 1 | |
| Channel Model | CDL-D | |
| Delay Spread | 20 | ns |
| Channel Normalization | True (Enabled) | |
| Subcarrier Spacing | 60 | kHz |
| Carrier Frequency | 915 | MHz |
| Number of RBs | 11 | |
| Bandwidth | 5 | MHz |
| Number of Bits per Symbol | 6 | bits |
| Coderate | 517/1024 | |
| WTRU Velocity | [0, 10] | km/h |

| | |
|---|---|
| SNR | [10 dB, 20 dB] |

The online constellation learning is performed through a hybrid supervised learning and reinforcement learning. Specifically, the SSD is first pre-trained using supervised learning with a standard QAM constellation. Once the SSD pre-training is completed, a learnable constellation is trained jointly with the pretrained SSD using reinforcement learning as described above and herein. The AI/ML model training parameters are given in Table 2.

TABLE 2
AI/ML model training parameters

| Number of slots for pretraining the SSD | 10000 Slots |
|---|---|
| Batch size for pretraining the SSD | 300 |
| Number of slots for Constellation | 2000 |
| Learning | |
| Batch size for Constellation | 32 |
| Learning | |
| Optimizer | Adam |
| Learning Rate at the Transmitter | 0.016 |
| Learning Rate at the Receiver | 0.009 |
| Perturbation variance | 0.03 |

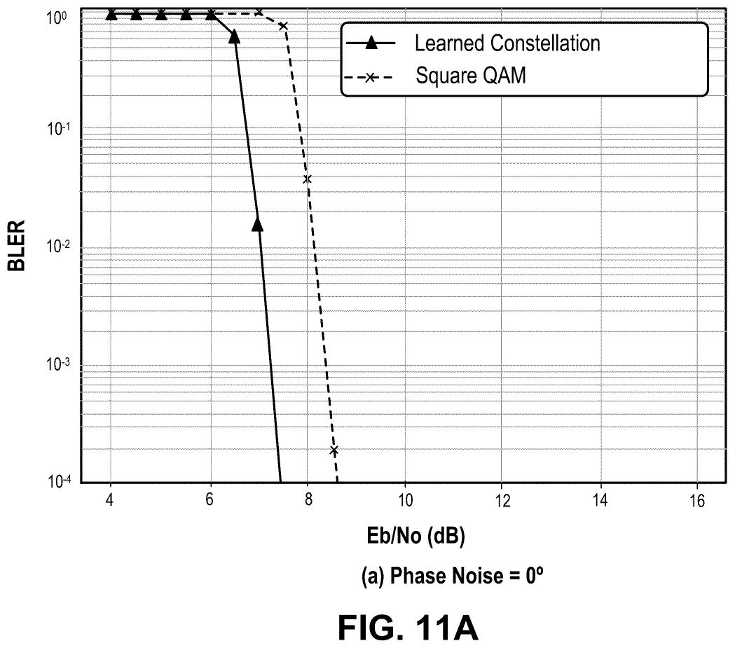

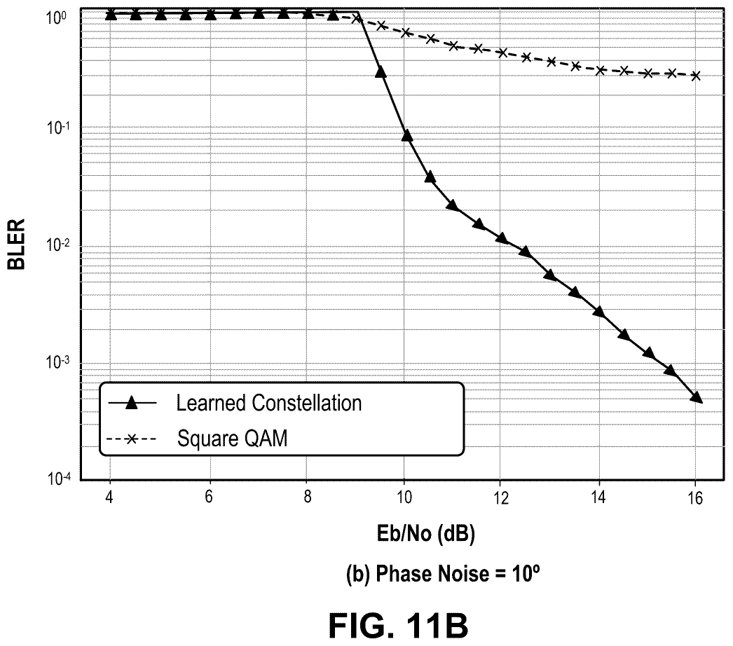

Regarding the hardware impairments, two cases may be considered: (i) phase noise=0°, (ii) phase noise=10°. FIGS. 11A and 11B present the BLER performance versus SNR, where two proposed scenarios are compared with the traditional square-QAM. The numerical result in FIG. 11A shows that with phase noise is 0°, learned constellation achieves 0.4 dB improvement in SNR compared to the traditional square-QAM constellation. With phase noise=10°, FIG. 11B shows the traditional square-QAM constellation (e.g., legacy solution) is failing and diverging (e.g., extremely high BLER), whereas the proposed learned constellation can achieve acceptable BLER and meet target BLER values. This shows that when the hardware impairments exist, learned constellation produce significantly higher performance improvement over the traditional square-QAM constellation.

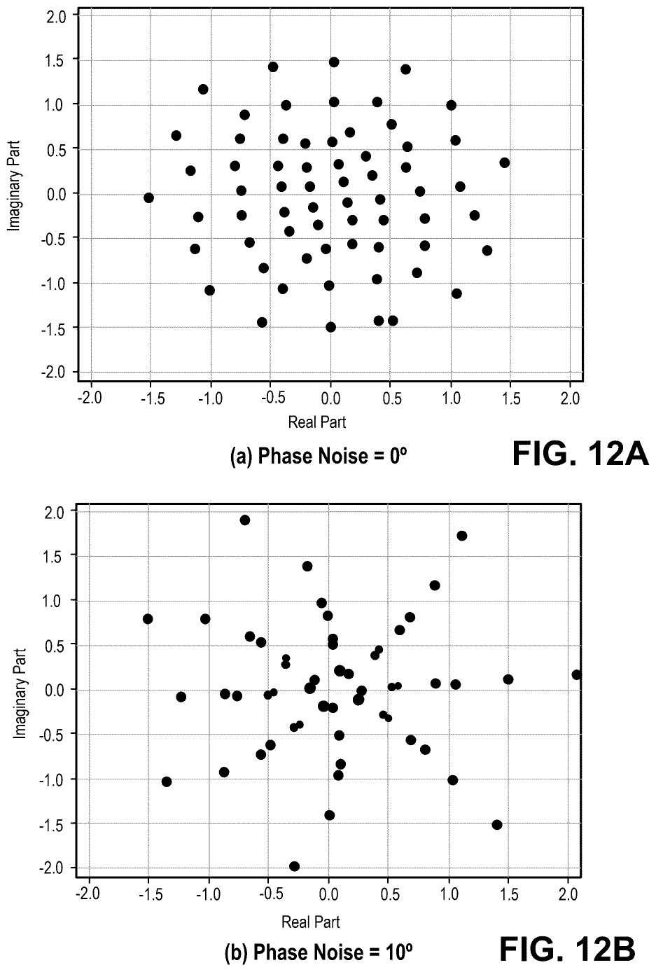

FIG. 12 demonstrates the real and imaginary parts of each symbol points in the learned constellations when the constellation and demapper are learned together. FIG. 12A presents the learned constellation when the phase noise is 0°. When the hardware impairment is introduced with the phase noise of 10°, the symbols in the learned constellation are converging in the amplitude domain, while diverging from each other in angular domain as shown in FIG. 12B.

Receiver-side training for online constellation learning in uplink (UL) may be implemented. Online constellation learning improves the end-to-end system performance (e.g., BER, BLER, throughput), while adapting to the hardware/radio impairments and dynamic channel conditions. The example methods herein may present the steps and/or procedures that enable online constellation learning for uplink through training at the receiver side (e.g., receiver-side training). The example methods herein may first enable configuring the WTRU (e.g., transmitter) with one or more initial constellation(s) (e.g., square QAM, trained/pre-trained non-square QAM). For the receiver-side training for online constellation learning in UL, the WTRU (e.g., transmitter) may use the uplink training bits (e.g., data bits, pseudo-random data bits, etc.) to create the modulated symbols, which are transmitted over-the-air to the NW (e.g., receiver). By using the uplink training bits, the NW may calculate learned constellation performance metrics (e.g., AI/ML model loss, BER, approximate BER, BLER, throughput, etc.). The NW may train one or more second constellation(s) (e.g., through reinforcement learning) by using the learned constellation performance metrics. The NW may transmit the one or more second (e.g., trained) constellation(s) to the WTRU.

AI/ML for constellation learning in uplink may be implemented. The constellation learning may be a function that is based on two AI/ML models, one residing at the WTRU, and one residing at the NW. The AI/ML model residing at the WTRU, referred to as a constellation and/or a constellation mapper, may map the data bits at the WTRU to complex constellation symbols to be transmitted to the NW through the uplink transmission chain (e.g., resource mapping, precoding, etc.). The AI/ML model residing at the NW, referred to as the soft symbol demapper, may map the equalized complex symbols from the WTRU to log likelihood ratios (LLRs) and/or hard bits, which can be then converted back to data bits. The application of AI/ML is the online constellation learning. The stages of the AI/ML process may be as follows.

For example, a stage of the AI/ML process may include an input data stage. The input data stage may include, for example, a constellation (e.g., uplink training bits), and/or a soft symbol demapper (e.g., equalized complex symbols at the WTRU; the estimated noise power at the NW may be also part of the AI/ML model input). A stage of the AI/ML process may include a preprocessing stage. The preprocessing stage may include, for example, a constellation (e.g., an optional preprocessing for the constellation may be applying channel encoding to the uplink training bits), and/or a soft symbol demapper (e.g., concatenation of the real and imaginary parts of the complex symbols to obtain the real-valued input to the AI/ML model). A stage of the AI/ML process may include an AI/ML model stage. The AI/ML model stage may include, for example, a constellation (e.g., an AI/ML model for the constellation mapper is depicted in diagram 600 of FIG. 6, which may consist of an input layer, multiple fully connected layers, and/or an output layer), and/or a soft symbol demapper (e.g., AI/ML model for the soft symbol demapper is depicted in diagram 700 of FIG. 7, which may consist of an input layer, multiple fully connected layers, and/or an output layer). A stage of the AI/ML process may include an output data stage. The output data stage may include, for example, a constellation (e.g., assuming that the constellation to be learned has an order of M, i.e., M constellation points, the input to the AI/ML model may be a codeword with log₂ M bits and the output of the AI/ML are the real and imaginary parts of the constellation point associated to the input codeword), and/or a soft symbol demapper (e.g., assuming that the constellation to be learned has an order of M, i.e., M constellation points, the inputs to the AI/ML model may be the real and imaginary parts of the received equalized symbol at the NW along with an estimate of the noise power at the NW and the output of the AI/ML model are the log₂ M LLRs associated to the log₂ M bits of the original codeword input to the constellation mapper).

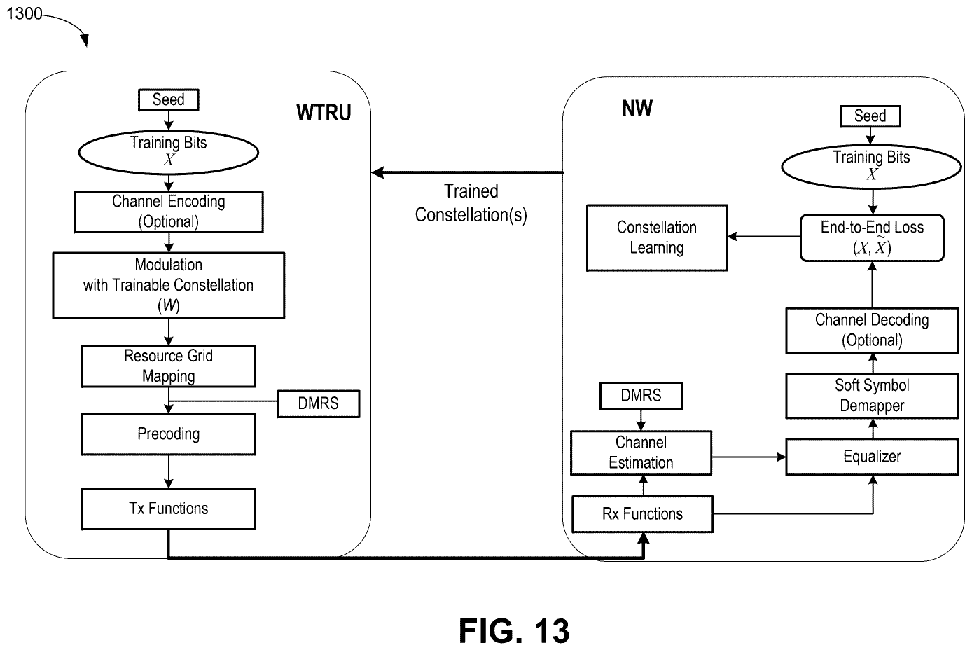

A stage of the AI/ML process may include a training stage. The WTRU may send the uplink training bits for the online constellation learning as shown in diagram 1300 of FIG. 13. The training of constellation may be performed at the receiver-side (e.g., NW-side). The training may be performed through reinforcement learning. In some examples, the NW may compute the learned constellation performance metrics (e.g., uncoded BER, BER, approximate BER, BLER, throughput, AI/ML model loss, etc.) of one or more initial constellations. The NW may update the parameters of its AI/ML-based SSD based on the computed learned constellation performance metrics. The NW may train the constellation through reinforcement learning. In some examples, a reinforcement learning agent may be located at the NW. In some examples, symbol points in the constellation and other metrics (e.g., SNR and/or SINR of the channel) may represent the state. In some examples, the NW may calculate the reward by using the learned constellation performance metrics (e.g., the reward may be a vector constructed from a metric associated with each perturbation, for example, mean BCE taken over all REs with the same perturbation). In some examples, an agent may take an action to update the symbol points in the learned constellation (e.g., the agent may apply a perturbation vector to the constellations representing the action of reinforcement learning agent; the perturbation vector may include the perturbations for each symbol point in the learned constellation). In some examples, the decided action by the agent may move the environment from its current state to a new state.

WTRU capability exchange may be implemented. The NW may initiate the WTRU capability exchange process by sending the UECapabilityEnquiry RRC message to the WTRU. This message may be used to request specific information regarding the WTRU's capabilities. The NW may include parameters in this message to specify which capabilities it is interested in. In some examples, the NW may specify parameters related to WTRU's capability in supporting online constellation learning in uplink in UECapabilityEnquiry message (e.g., the capability of applying learned constellation to uplink bits).

Upon receiving the UECapabilityEnquiry RRC message, the WTRU may respond with the UECapabilityInformation RRC message accordingly. This message may include detailed information about the WTRU's capabilities. During the WTRU capability exchange process between the WTRU and the NW, the following key parameters related to the AI/ML functions may be included. For example, a key parameter related to the AI/ML functions may include an indicator of whether online constellation learning in uplink is supported or not. A key parameter related to the AI/ML functions may include an indicator of whether the configuration of multiple learned constellations is supported or not. A key parameter related to the AI/ML functions may include an indicator of whether reporting one or more trained constellations is supported or not. A key parameter related to the AI/ML functions may include an indicator of whether generating the uplink training bits is supported or not. For instance, the WTRU may generate the uplink training bits through the same pseudo-random bit generator as in NW and with the seeds configured by the NW.

Through the WTRU capability exchange process as described above and herein, the NW may know the WTRU's capability to support the receiver-side training of constellation learning in uplink and use the learned constellation. For a WTRU that is capable of supporting such a function and/or feature, key parameters may be configured by the NW, which may include the following. In some examples, a key parameter that may be configured by the network may include the configuration for one or more initial constellation(s). For example, the WTRU may be configured with multiple initial constellations, for instance, a single constellation per sub-band, per Precoding Resource Block Group, and/or RB set (e.g., the first sub-band may be configured with a constellation with 16 symbols (i.e., 4 bits per symbol), while the second sub-band may be configured with a constellation with 64 symbols (i.e., 6 bits per symbol)). For example, the configured initial constellation may include a previously trained/learned constellation under a similar condition (e.g. channel conditions, hardware impairments), a trained/learned constellation during online constellation learning iterations, and/or a square QAM constellation for the first iteration of online constellation learning.

In some examples, a key parameter that may be configured by the network may include the configuration for reporting one or more trained constellations. For instance, the reporting periodicity (e.g., periodic, semi-persistent, and/or aperiodic).

In some examples, a key parameter that may be configured by the network may include the configuration for online constellation learning training allocations. For example, the WTRU may transmit uplink training bits through online constellation learning training allocations. Seeds may be used to generate the uplink training bits at the WTRU. The uplink training bits may include, for example, pseudo-random data bits generated through a seed (e.g., the WTRU may generate the uplink training bits through a pseudo-random bit generator initialized with the configured seeds. The configuration may include a code rate of forward error correction (FEC) (e.g., low density parity check (LDPC).

In some examples, a key parameter that may be configured by the network may include the configuration for learning a constellation. For instance, the configuration for learning a constellation may include for each modulation order greater than 2 bits/symbol through the configured SNR_min and SNR_max for each modulation order. The configuration for learning a constellation may include for each modulation order and code rate (e.g., per MCS) through the configured of SNR_min and SNR_max for each MCS. The configuration for learning a constellation may include for each combination of MCS (with its associated SNR range) and hardware/radio impairment class through the configured of SNR_min and SNR_max for each MCS and partitioned channel BW having a common class of hardware/radio impairments. In some examples, a key parameter that may be configured by the network may include the downlink resource allocation for receiving the one or more trained constellations.

The following signals and/or signaling may be defined to enable the WTRU and/or NW to detect the need for initiating online constellation learning, and to enable the WTRU to use the learned constellation(s). In some examples, a signaling may be defined to enable the WTRU to receive training activation for the online constellation learning transmitted from the NW to the WTRU (e.g., through DCI or MAC-CE). In some examples, a signaling may be defined to enable the WTRU to receive configuration for online constellation learning training allocations transmitted from the NW to the WTRU. In some examples, a signaling may be defined to enable the WTRU to receive trained constellation(s) transmitted from the NW to the WTRU (e.g., through DCI or MAC-CE).

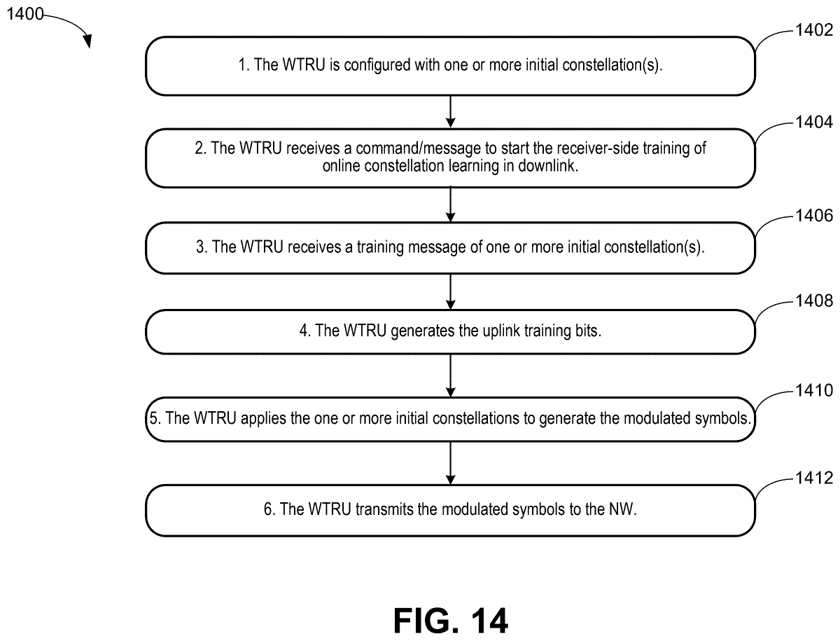

The methods and/or procedures for enabling the receiver-side training for online constellation learning for uplink are detailed below and summarized in FIG. 14. The NW may refer to any node in the network, for example, gNB, another WTRU (e.g., Sidelink, WTRU-to-WTRU direct communication), etc.

In some examples, the WTRU may be configured (e.g., through RRC signaling) with one or more constellation(s). The WTRU may be configured with multiple constellations (e.g., a single constellation per sub-band, per Precoding Resource Block Group, per RB set, and/or per layer). For example, each sub-band may be configured with a constellation. The configured constellations may have different modulation orders. For example, the first sub-band is configured with a constellation with 16 symbols (i.e., 4 bits per symbol), while the second sub-band is configured with a constellation with 64 symbols (i.e., 6 bits per symbol). The configured initial constellation may include one or more of the following. For example, the configured initial constellation may include a previously trained/learned constellation under a similar condition (e.g. channel conditions, hardware impairments). The configured initial constellation may include a trained/learned constellation during online constellation learning iterations. The configured initial constellation may include a square QAM constellation for the first iteration of online constellation learning.

In some examples, the WTRU may receive a command and/or message to start the receiver-side training for online constellation learning for uplink. Triggers to initiate constellation learning include one or more of the following. A trigger to initiate constellation learning may include, for example, the WTRU being configured to use AI/ML for constellation learning (e.g., for a first time). A trigger to initiate constellation learning may include, for example, the WTRU (or the NW) detecting a need to start constellation learning and/or shaping. For instance, AI/ML model's drift detection mechanisms at the WTRU and/or the NW may indicate that the AI/ML models have drifted and/or are drifting. The WTRU may enter a geographic region and/or a cell (e.g., a new cell ID and/or a new registration area) for which the constellation has not been previously trained. For example, the WTRU may compare global positioning system (GPS) coordinates to measure distance to previously trained regions. If distance is above a threshold provided by the NW, the WTRU may signal the NW indicating the threshold is exceeded, and/or possibly the distance and the current location. The training for the online constellation learning may be periodic, aperiodic, and/or semi-persistent.

In some examples, the WTRU may receive (e.g., from the NW) a training message (e.g., through downlink control information (DCI)) for the receiver-side training for online constellation learning for uplink of one or more initial constellation(s). The training message may be configured either by RRC signaling and/or be dynamically signaled by DCI and/or MAC-CE. The training message may include one or more of the following. For example, the training message may include training related information. The training related information may include seed(s) to generate the uplink training bits used by the WTRU. The training related information may include a set of code rates for FEC (e.g., LDPC). The set of code rates may be a code rate for each configured constellation. The set of code rates may be a fixed code rate for all configured constellations.

The training message may include online constellation learning training allocations. For example, the online constellation learning training allocations may be a set of physical uplink shared channel (PUSCH) REs on which the WTRU transmits the symbols modulated by a set of uplink training bits during online constellation learning training allocations. Examples of the set of uplink training bits may include pseudo-random data bits generated through one or more configured seeds, data bits, and/or a preconfigured set of data bits.

In some examples the WTRU may generate the uplink training bits based on the constellation learning training allocation. For example, the WTRU may employ a pseudo-random bit generator with the same seeds configured by the NW. In some examples, The WTRU may apply the one or more initial constellations to generate the modulated symbols (e.g., modulated uplink data bits or modulated uplink training bits). The WTRU may transmit the modulated symbols (e.g., modulated uplink data bits or modulated uplink training bits) to the NW.

FIG. 14 is an example of a procedure 1400 for WTRU procedures for receiver-side training for online constellation learning in uplink. The procedure 1400 may be performed by a WTRU. At 1402, the WTRU may be configured with one or more initial constellation(s). At 1404, the WTRU may receive a command and/or message to start the receiver-side training of online constellation learning in downlink. At 1406, the WTRU may receive a training message of one or more initial constellation(s). At 1408, the WTRU generates the uplink training bits. At 1410, the WTRU applies the one or more initial constellations to generate the modulated symbols. At 1412, the WTRU transmits the modulated symbols to the NW.

1. A wireless transmit/receive unit (WTRU) comprising:
a processor configured to:
receive configuration information from a network, wherein the configuration information comprises one or more initial constellations associated with an artificial intelligence (AI)/machine learning (ML) constellation model;
receive a training message, wherein the training message comprises an online constellation learning training allocation associated with the one or more initial constellations and one or more thresholds;
determine estimated downlink training bits or symbols based on the online constellation learning training allocation and the one or more initial constellations;
recreate downlink training bits or symbols used by a network;
determine one or more constellation performance metrics for the one or more initial constellations based on the recreated downlink training bits and the estimated downlink training bits;
determine that training of the AI/ML constellation model is not complete based on the one or more constellation performance metrics and the one or more thresholds;
train one or more second constellations based on the determination that the AI/ML constellation model is not complete;
generate one or more perturbation vectors based on the one or more trained second constellations;
determine one or more perturbated trained second constellations by applying the generated one or more perturbation vectors to the one or more trained second constellations; and
report the one or more perturbated trained second constellations to the network.

2. The WTRU of claim 1, wherein the downlink training bits comprise data bits or pseudo-random data bits.

3. The WTRU of claim 2, wherein the downlink training bits comprise pseudo-random data bits, wherein the training message comprises one or more seed values; and
wherein the processor is configured to recreate the downlink training bits using the one or more seed values and a pseudo-random number generator.

4. The WTRU of claim 2, wherein the downlink training bits comprise data bits; and
wherein the processor is configured to recreate the downlink training bits by reencoding decoded bits after verification by running a cyclic redundancy check (CRC).

5. The WTRU of claim 1, wherein the online constellation learning training allocation comprises a set of physical downlink shared channel (PDSCH) resource elements (REs) carrying symbols modulated by the downlink training bits.

6. The WTRU of claim 5, wherein the processor is configured to:
receive the set of PDSCH REs carrying the symbols that were modulated by the downlink training bits; and
determine the estimated downlink training bits based on the symbols and the one or more initial constellations.

7. The WTRU of claim 1, wherein the constellation performance metrics comprises one or more of uncoded bit error rate (BER), BER, approximate BER, throughput, or AI/ML model loss.

8. The WTRU of claim 1, wherein the processor is configured to compute a measured statistic that quantifies a relation between the recreated downlink training bits and the estimated downlink training bits to determine the constellation performance metrics.

9. The WTRU of claim 1, wherein the processor is configured to send a report to the network, wherein the report comprises the constellation performance metrics.

10. The WTRU of claim 1, wherein the training message comprises an uplink resource allocation for reporting the one or more constellation performance metrics, and wherein the processor is configured to send the one or more constellation performance metrics via the uplink resource allocation indicated by the training message.

11. The WTRU of claim 1, wherein the processor is configured to report one or more constellation performance metrics to the network.

12. The WTRU of claim 1, wherein the training message comprises a set of thresholds, and wherein the processor is configured to determine if the training of AI/ML constellation model is complete based on the determined constellation performance metrics and the set of thresholds.

13. The WTRU of claim 1, wherein the processor is configured to send a message to the network indicating that the training of the AI/ML constellation model is complete if the training of AI/ML constellation models is complete.

14. The WTRU of claim 1, wherein the processor is configured to:
train one or more additional second constellations;
generate one or more additional perturbation vectors;
determine one or more additional perturbated trained second constellations by applying the generated one or more additional perturbation vectors to the one more trained additional second constellations; and
report the one or more additional perturbated trained second constellations to the network if the training of AI/ML constellation model is not complete.

15. The WTRU of claim 1, wherein the processor is configured to receive indication from the network to start a receiver-side training of online constellation learning in downlink.

16. A method performed by a wireless transmit/receive unit (WTRU), the method comprising:
receiving configuration information from a network, wherein the configuration information comprises one or more initial constellations associated with an artificial intelligence (AI)/machine learning (ML) constellation model;
receiving a training message, wherein the training message comprises an online constellation learning training allocation associated with the one or more initial constellations and one or more thresholds;
determining estimated downlink training bits or symbols based on the online constellation learning training allocation and the one or more initial constellations;
recreating downlink training bits or symbols used by a network;
determining one or more constellation performance metrics for the one or more initial constellations based on the recreated downlink training bits and the estimated downlink training bits;
determining that training of the AI/ML constellation model is not complete based on the one or more constellation performance metrics and the one or more thresholds;
training one or more second constellations based on the determination that the AI/ML constellation model is not complete;
generating one or more perturbation vectors based on the one or more trained second constellations;
determining one or more perturbated trained second constellations by applying the generated one or more perturbation vectors to the one or more trained second constellations; and
reporting the one or more perturbated trained second constellations to the network.

17. The method of claim 16, wherein the downlink training bits comprise data bits or pseudo-random data bits.

18. The method of claim 17, wherein the downlink training bits comprise pseudo-random data bits, wherein the training message comprises one or more seed values, and wherein the method further comprises recreating the downlink training bits using the one or more seed values and a pseudo-random number generator.

19. The method of claim 17, wherein the downlink training bits comprise data bits, and wherein the method further comprises recreating the downlink training bits by reencoding decoded bits after verification by running a cyclic redundancy check (CRC).

20. The method of claim 16, wherein the online constellation learning training allocation comprises a set of physical downlink shared channel (PDSCH) resource elements (REs) carrying symbols modulated by the downlink training bits.
